(19) United States
(12) Patent Application Publication
(10) Pub. No.: US 2008/0249649 A1
(43) Pub. Date: Oct. 9, 2008

(54) LASER PROJECTOR CONTROL SYSTEM

(75) Inventors: Jeff Welch, Lakeside (CA); Robert Sandness, King City (CA); Declan Whelan, Guelph (CA)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: VIRTEK VISION INTERNATIONAL INC., Waterloo (CA)

(21) Appl. No.: 12/061,997

(22) Filed: Apr. 3, 2008

Related U.S. Application Data
(60) Provisional application No. 60/921,667, filed on Apr. 3, 2007.

(51) Int. Cl. G06F 17/00

(52) U.S. Cl. 700/117

(57) ABSTRACT

A laser projector system includes a computer and a laser projector for projecting a laser image on a target surface, particularly in a factory or manufacturing environment. The computer is disposed remote from the laser project and provides the laser projector with a command and control signal. Communication between the computer and the laser projector is accomplished with power line network adapters. These adapters modulate an AC waveform to encode the command and control signal and other data. Thus, communication between the computer and the laser projector is accomplished without need for long runs of communication cables.

### CROSS REFERENCE TO RELATED APPLICATION

This application claims the benefit of U.S. provisional patent application No. 60/921,667, filed Apr. 3, 2007.

### BACKGROUND OF THE INVENTION

1. Field of the Invention

The subject invention relates to a laser projector control system. Specifically, the system relates to control of laser projectors from a computer.

2. Description of the Related Art

Laser projectors are routinely used to project images onto a surface. This is typically accomplished by scanning a laser beam, i.e., movably deflecting the light generated by a laser. Such laser projector systems are well known to those skilled in the art as is shown by U.S. Pat. Nos. 5,237,444 and 5,381,258, which are hereby incorporated by reference.

Such laser projectors are typically controlled by a computer, as is shown in FIG. 1. The computer runs software to generate command and control instructions that are communicated to the laser projectors such that an image may be generated on a surface. More specifically, the computer is often a stand-alone PC. Communication between the computer and the laser projectors are accomplished via communication cables, such as Ethernet cables, which are well known to those skilled in the art.

However, accurate data communication over such communication cables can be limited by length cable runs, particularly in a manufacturing environment. Signal degradation may occur in long cable runs, even when the cable runs are around 25 feet long. Furthermore, long runs of communication cable can be very costly and difficult to implement. Moreover, the use of hubs, routers, and other such communication repeaters to improve signal degradation may also be cost prohibitive.

Therefore, there remains an opportunity for a laser projector system that can provide communications between a computer and a laser projector, particularly in a manufacturing environment, without the use of length communication cables.

### SUMMARY OF THE INVENTION AND ADVANTAGES

The subject invention provides a laser projector system for use in a manufacturing environment. The system includes a laser projector having a receiver for receiving a command and control instruction and a laser for projecting a laser image on a target surface in accordance with the command and control instruction. A computer is disposed remote from the laser projector and has software to produce the command and control instruction for controlling the projection of the laser projector. A computer-side power line network adapter is electrically connected to an AC power distribution system and in communication with the computer for receiving the command and control instruction from the computer and transmitting a signal corresponding to the command and control instruction over the AC power distribution system. The system also includes a projector-side power line network adapter electrically connected to the AC power distribution system and in communication with the laser projector for receiving the signal from the AC power distribution system and transmitting the command and control instruction to the laser projector. The power line network adapters cooperate to communicate the command and control instruction in the manufacturing environment where power surges and power line noise are known to disrupt AC power distribution

The subject invention also provides a method of remotely controlling a laser projector in a factory environment. The method includes the step storing a command and control instruction on a computer for use with a laser projector disposed remote from the computer. The computer and the laser projector are electrically connected to an AC power distribution system. The method also includes the step of sending the command and control instruction to the laser projector from the computer via a signal transmitted over the AC power distribution system. The method further includes the step of controlling the projection of the laser projector utilizing the command and control instruction received from the AC power distribution system.

By utilizing the AC power distribution system, the subject invention provides communication between the computer and the laser projector using existing electric wiring. This reduces the need for communication cabling, e.g., Ethernet. This reduced need provides numerous cost savings because length communication cable runs with periodic repeaters are not necessary. Furthermore, the computer and/or laser projector scan be easily moved from one position to another inside a manufacturing environment without rerouting communication cables.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an electrical schematic diagram of a laser projector system of the prior art;

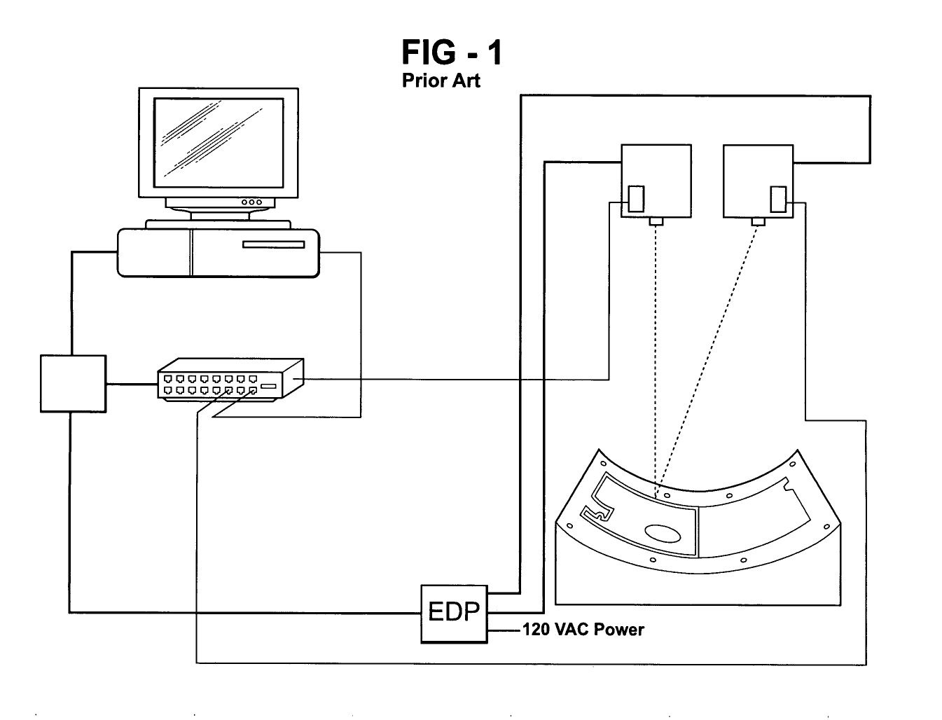

FIG. 2 is an electrical schematic diagram of a first embodiment of a laser projector system of the present invention; and

FIG. 3 is an electrical schematic diagram of a second embodiment of the laser projector system of the present invention.

### DETAILED DESCRIPTION OF THE INVENTION

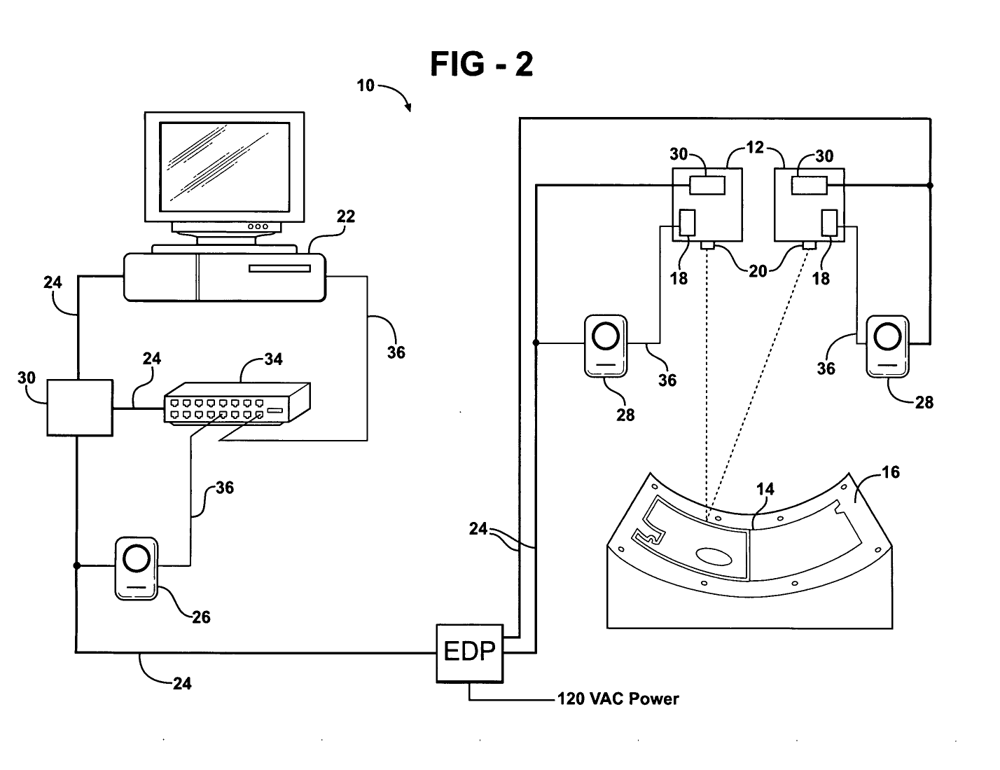

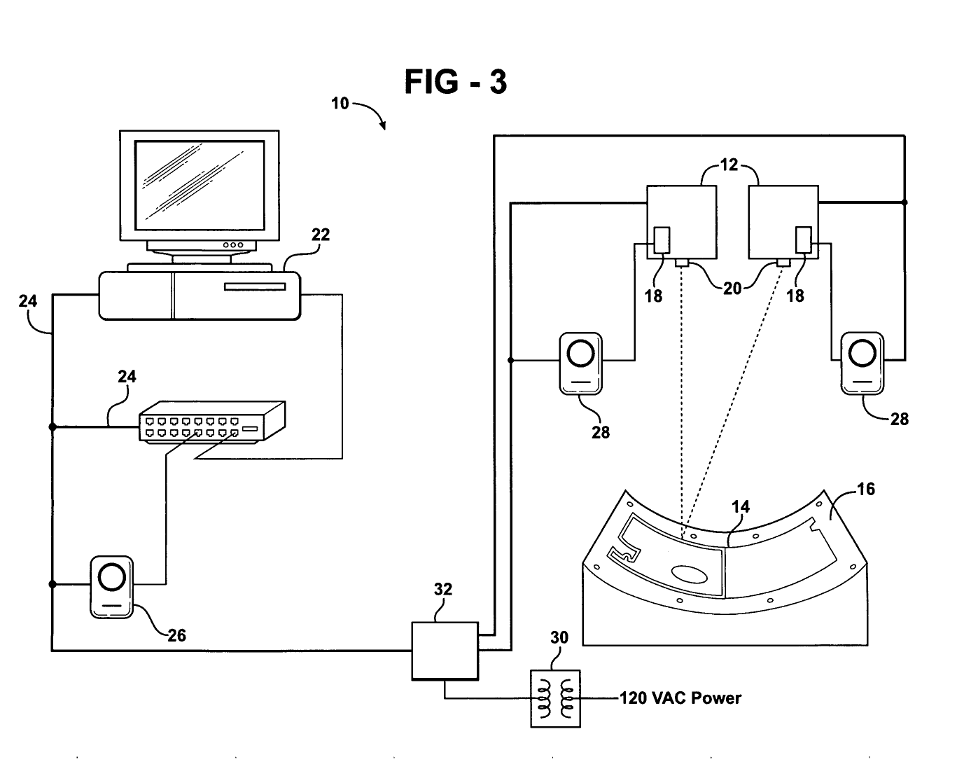

Referring to the FIGS. 2 and 3, wherein like numerals indicate corresponding parts throughout the several views, a laser projector system is shown at 10. The system 10 is ideally suited for use in a factory or other such manufacturing environment. However, those skilled in the art realize that the system 10 may be utilized in other environments without limitation.

The system 10 includes at least one laser projector 12. The laser projector 12 is utilized to project a laser image 14 on a target surface 16. In the illustrated embodiments, as shown in FIG. 2 and 3, the target surface 16 is a curved surface, such as part of a fuselage of an aircraft. The laser image 14 allows for accurate painting or application of decals to the curved, target surface 16. However, those skilled in the art realize other suitable and useful applications for the laser projector 12. Furthermore, a plurality of laser projectors 12 may be utilized to produce the laser image 14 on the curved surface 16. FIGS. 2 and 3 show two laser projectors 12 being utilized, but this quantity of laser projectors 12 should in no way be read as limiting.

Each laser projector 12 includes a receiver 18 for receiving a command and control instruction and a laser 20 for projecting the laser image 14 on the target surface 16 in accordance with the command and control instruction. The command and control instruction is the data and programs necessary to operate the laser 20 to produce the desired laser image 14. Of course, the command and control instruction may be implemented as a plurality of instructions. For the purposes of clarity, the singular term instruction is used herein and should not be regarded as limiting to a single instruction.

The system 10 includes a computer 22 disposed remote from the laser projector 12. The computer 22 may be implemented as a standard desktop PC having a microprocessor, data storage capabilities (e.g. disk drives), and input/output devices (e.g., monitor, keyboard, mouse). Those skilled in the art realize other techniques for implementing the computer 22. The computer 22 includes software, i.e., a program, to produce the command and control instruction for controlling the projection of the laser projector 12. Such software is known to those skilled in the art. In the illustrated embodiment, where there are multiple laser projectors 12, the computer 22 preferably provides separate command and control instructions for each laser projector 12.

The system 10 utilizes power line network adapters to communicate the command and control instructions as well as other data between the computer 22 and the laser projectors 12. The power line network adapters modulate an AC power signal to encode allow communication along power lines 24 of an AC power distribution arrangement (not numbered).

Specifically, the system 10 includes a computer-side power line network adapter 26 electrically connected to the one of the power lines 24 of the AC power distribution arrangement. The computer-side power line network adapter 26 is in communication with the computer 22 for receiving the command and control instruction from the computer 22. Specifically, in the illustrated embodiments, communication between the computer 22 and the computer-side power line network adapter 26 is accomplished over a communication cable 36, such as an Ethernet cable. The computer-side power line network adapter 26 transmits a signal corresponding to the command and control instruction over the power lines 24 of the AC power distribution system.

The system 10 of the illustrated embodiments also includes a hub 34 for assisting in communications between the computer 12 and the computer-side power line network adapter 26. The hub 34 may also be utilized to communicate with other electronic devices (not shown). However, those skilled in the art realize that the system 10 may be implemented without the hub 34 by utilizing a direct connection between the computer 12 and the computer-side power line network adapter 26.

The system 10 also includes a projector-side power line network adapter 28 electrically connected to the power lines 24 of the AC power distribution system. The projector-side power line network adapter 28 is in communication with the laser projector 12. Specifically, in the illustrated embodiments, communication between the laser projector 12 and the projector-side power line network adapter 28 is accomplished over a communication cable 36, such as an Ethernet cable. The projector-side power line network adapter 28 receives the signal from the AC power distribution system. The projector-side power line network adapter 28 then decodes the signal to determine the encoded data, including the command and control instruction. The projector-side power line network adapter 28 then transmits the command and control instruction to the laser projector 12. Of course, in the illustrated embodiments, as shown in FIGS. 2 and 3, the system 10 includes a plurality of projector-side power line network adapters 28 (one for each laser projector 12). Alternatively, a single projector-side power line network adapter 28 may be utilized to provide command and control instructions to more than one laser projector 12.

In the illustrated embodiments, the system 10 includes at least one power conditioner 30 electrically connected to the power lines 24 of the AC power distribution system. The power conditioner 30 conditions AC power from the power lines 24 to produce conditioned AC power. Said another way, the conditioned AC power is preferably free of voltage spikes or other waveform anomalies that may adversely effect or damage electronic equipment, such as the computer 22 and/or the laser projector 12. In one possible implementation, the power conditioner 30 is an uninterruptible power supply (UPS) having batteries to store electrical power and generate the conditioned AC power.

In a first embodiment, as shown in FIG. 2, a plurality of power conditioners 30 may be utilized. One power conditioner 30 is electrically connected to the laser projector 12 to power the laser projector 30 with conditioned AC power. Preferably, the power conditioner 30 is integrated with the laser projector 12. Alternatively, the power conditioner 30 may be a separate component from the laser projector 12. Furthermore, another power conditioner 30 is electrically connected to the computer 22 to power the computer 22 with conditioned AC power.

In a second embodiment, as shown in FIG. 3, the power conditioner 30 is implemented as an isolation transformer. The isolation transformer has a first side (not numbered) and a second side (not numbered). The first side is electrically connected to an AC power source. The second side is electrically connected to the laser projector 12, the computer 22, and the power line network adapters 26, 28. The system 10 of the second embodiment is particularly advantageous as the power line network adapters 26, 28 are protected from voltage spikes, surges, etc., in addition to protection of the computer 22 and laser projector 12.

The use of the power lines to communicate in a manufacturing environment is often difficult, and not known to be practiced in the case of laser projectors 12, because of power line noise and voltage spikes, surges, etc. This power line noise can severely disrupt communication resulting in poor performance. However, the system 10 of the illustrated embodiment allows consistent communication between the computer 22 and the laser projector 12.

The subject invention also provides a method of remotely controlling a laser projector. This method is particularly useful in a factory environment, as stated above. The method is described herein with respect to the system 10 of the subject invention. However, the method may be practices outside the aforementioned system 10.

The method includes the step of storing a command and control instruction on a computer for use with a laser projector disposed remote from the computer. The method also includes the step of electrically connecting the computer and the laser projector to an AC power distribution system. The method further includes the step of sending the command and control instruction to the laser projector from the computer via a signal transmitted over the AC power distribution system. Moreover, the method includes the step of controlling the projection of the laser projector utilizing the command and control instruction received from the AC power distribution system.

The present invention has been described herein in an illustrative manner, and it is to be understood that the terminology that has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A laser projector system for use in a manufacturing environment comprising:
a laser projector having a receiver for receiving a command and control instruction and a laser for projecting a laser image on a target surface in accordance with the command and control instruction;
a computer disposed at a remote location from said laser projector and having software to produce the command and control instruction for controlling the projection of said laser projector;
a computer-side power line network adapter electrically connected to an AC power distribution system and in communication with said computer for receiving the command and control instruction from the computer and transmitting a signal corresponding to the command and control instruction over the AC power distribution system; and
a projector-side power line network adapter electrically connected to the AC power distribution system and in communication with said laser projector for receiving the signal from the AC power distribution system and transmitting the command and control instruction to said laser projector wherein said power line network adapters cooperate to communicate the command and control instruction in the manufacturing environment where power surges and power line noise are known to disrupt AC power distribution.

2. A system as set forth in claim 1 further comprising a power conditioner electrically connected to said AC power distribution system for conditioning AC power from the AC power distribution system to produce conditioned AC power.

3. A system as set forth in claim 2 wherein said laser projector is electrically connected to said power conditioner for receiving the conditioned AC power to electrically power components of said laser projector.

4. A system as set forth in claim 3 wherein said power conditioner is integrated with said laser projector.

5. A system as set forth in claim 2 wherein said power conditioner is further defined as an uninterruptible power supply (UPS) having batteries to store electrical power.

6. A system as set forth in claim 2 wherein said power conditioner is further defined as an isolation transformer.

7. A system as set forth in claim 6 wherein said isolation transfer has a first side and a second side wherein the first side is electrically connected to an AC power source and second side is electrically connected to said laser projector, said computer, and said power line network adapters.

8. A system as set forth in claim 1 wherein said laser projector is further defined as a plurality of laser projectors.

9. A system as set forth in claim 8 wherein said computer provides separate command and control instructions for each of said laser projectors.

10. A system as set forth in claim 9 wherein said projector-side power line network adapter is in communication with each of said laser projectors for receiving the signal from the AC power distribution system and transmitting the applicable command and control instruction to each laser projector.

11. A system as set forth in claim 10 wherein said projector-side power line network adapter is further defined as a plurality of projector-side power line network adapters with each projector-side power line network adapter electrically connected to the AC power distribution system and in communication with one of said laser projectors for receiving the signal from the AC power distribution system and transmitting the applicable command and control instruction to said laser projector.

12. A method of remotely controlling a laser projector in a factory environment, said method comprising the steps of:
storing a command and control instruction on a computer for use with a laser projector disposed remote from the computer;
electrically connecting the computer and the laser projector to an AC power distribution system;
sending the command and control instruction to the laser projector from the computer via a signal transmitted over the AC power distribution system;
controlling the projection of the laser projector utilizing the command and control instruction received from the AC power distribution system.
